(19) United States
(12) Patent Application Publication
(10) Pub. No.: US 2007/0101742 A1
(43) Pub. Date: May 10, 2007

(54) A COOLING SYSTEM FOR SUPERCONDUCTING MAGNETS

(76) Inventors: Evangelos T. Laskaris, Schenectady, NY (US); Xianrui Huang, Clifton Park, NY (US); Paul S. Thompson, Stephentown, NY (US); Ernst Wolfgang Stautner, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/164,124

(22) Filed: Nov. 10, 2005

(51) Int. Cl. F17C 5/02; F25D 23/12

(52) U.S. Cl. 62/259.2; 62/47.1

(57) ABSTRACT

A cooling system is in thermal contact with a magnet and provides cooling thereto. A storage tank is fluidly connected to the cooling system to store gas released by the cooling system. The stored gas may then be released back into the cooling system when needed.

### BACKGROUND OF THE INVENTION

The present invention relates generally to a cooling system for a superconductor, more particularly, to a cooling system having a reclamation circuit for retaining boil-off coolant within the superconductor cooling system.

A superconducting magnet generally uses liquid cryogens to keep its superconducting coils cold for superconducting operations. A closed cryogenic cooling system typically includes a cryogen liquid tank and a cryocooler recondensing unit. During normal superconducting operations, such a closed cryogenic system provides cooling to balance the heat load of the superconducting magnet so that no cryogen is lost. However, during a power outage or other system failure when the cooling power is lost, the superconducting magnet heat load tends to increase the pressure and the temperature of the cryogen. In an attempt to retain the pressure and temperature within a typical closed cryogenic cooling system, gaseous cryogen is released or boiled-off into the atmosphere through a pressure relief valve. As such, the boiled-off cryogen is lost to the atmosphere.

The cryogen from the system that is vented needs to be replaced when the system failure is corrected and the system returns to normal operation. Refilling the closed cryogenic cooling system usually requires that a cryogenic service perform a service call to refill the system. Such cryogenic services add service costs to the system, especially in areas where there is no established cryogenic service network. Furthermore, in systems such as an MRI scanner having a superconducting magnet, waiting for a cryogenic service to perform a service call increases the down-time of the scanner.

It would therefore be desirable to have a system and capable of reclaiming and storing boiled-off cryogen within a closed cryogenic cooling system.

### BRIEF DESCRIPTION OF THE INVENTION

The present invention provides a cooling system for a superconducting magnet that overcomes the aforementioned drawbacks. A closed cryogenic cooling system includes a cryogen liquid tank, a cryogen storage tank, and a cryocooler recondensing unit. The cryocooler recondensing unit provides cooling to balance the magnet heat load during normal operation. During a power outage or other failure of the cryocooler recondensing unit, boiled-off gas is reclaimed in the storage tank. Upon re-initialization of the system, the stored boil-off gas is re-introduced into the system for cooling the superconducting magnet.

Therefore, in accordance with one aspect of the invention, a magnet assembly includes a magnet and a cooling system in thermal contact with the magnet. A tank is fluidly connected to the cooling system and configured to receive and store boil-off fluid emitted from the cooling system.

In accordance with another aspect of the invention, a superconductor system includes a superconducting magnet and a refrigerant in thermal contact with the superconducting magnet and configured to cool the superconducting magnet. A cooling system is included that is configured to condense the refrigerant from a gaseous state to a liquid state. A storage tank is fluidly connected to the cooling system and configured to store discharged refrigerant released from the cooling system.

In accordance with a further aspect of the invention, an MRI apparatus includes a magnetic resonance imaging (MRI) system having a plurality of gradient coils positioned about a bore of a magnet to impress a polarizing magnetic field and an RF transceiver system and an RF switch controlled by a pulse module to transmit RF signals to an RF coil assembly to acquire MR images. A cryogenic cooling system is included and is in thermal contact with the magnet. A cryogen reclamation circuit is included and is fluidly connected to the cryogenic cooling system, and configured to store boiled-off cryogen released by the cryogenic cooling system.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a schematic diagram of a closed-loop magnet cooling system in accordance with the present invention.

FIG. 2 is a schematic block diagram of an MR imaging system for use with the present invention.

### DETAILED DESCRIPTION OF THE PREFERRED EMBODIMENT

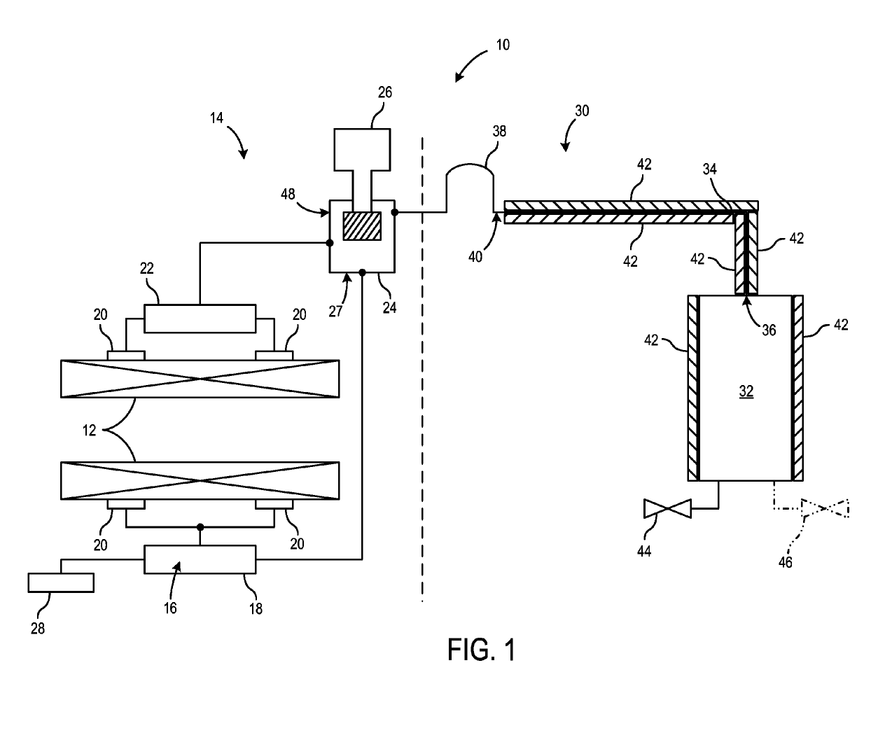

Referring to FIG. 1, a preferred closed-loop magnet cooling system 10 according to the present invention is shown. Magnet 12 is actively cooled to support superconducting operation by a cooling system 14 having a plurality of coolant tubes thermally connected to coils (not shown) of the magnet 12. In this regard, in a preferred embodiment, magnet 12 is a superconducting magnet having an arrangement of coils that create a magnetic field when current is passed therethrough. Cooling system 14 passes refrigerant 16, such as helium, nitrogen, neon or the like, past the coils of the magnet 12 such that the temperature of magnet 12 is below a superconducting critical temperature. Preferably, refrigerant 16 is a cryogen.

Cooling system 14 includes a liquid mass collector 18 positioned such that liquid refrigerant 16 flows thereinto by gravity. Preferably, liquid mass collector 18 is positioned below magnet 12. The cooling system 14 includes cooling tubes or risers 20 that surround magnet 12 and allow thermal communication between magnet 12 and refrigerant 16. Risers 20 are in flow communication with the liquid mass collector 18. In this manner, refrigerant 16 may flow from the liquid mass collector 18 into the risers 20.

A gas collector 22 is fluidly connected to risers 20 and collects gaseous refrigerant. During normal operating conditions, refrigerant 16 is maintained at a constant boiling-point temperature. In this manner, the refrigerant is distributed throughout the risers 20 to cool magnet 12. As boiling refrigerant passes through the risers 20, gaseous refrigerant rises from the risers 20 into the gas collector 22.

A liquefaction cup 24 is fluidly connected to the gas collector 22 and receives gaseous refrigerant. A cryocooler recondenser or cold head 26 is attached to the liquefaction cup 24 and condenses the gaseous refrigerant in the liquefaction cup 24 to liquid refrigerant. The liquid refrigerant falls to the bottom 27 of the liquefaction cup 24 and, with the aid of gravity, results in the liquid refrigerant flowing into the liquid mass collector 18.

The cryocooler recondenser 26, in general, produces more cooling than the total heat load of the magnet 12. A heater 28 is fluidly connected to the liquid mass collector 18 and adds heat to the cooling system 14 to increase the pressure and temperature of the refrigerant 16 to a normal operating pressure and temperature. In a preferred embodiment, heater 28 is a pressure sensor controlled heater.

During normal operating conditions, cooling system 14 maintains an equilibrium of the refrigerant 16 in the system. That is, gaseous refrigerant that evaporates from the liquid refrigerant is re-condensed back into liquid refrigerant. However, during a failure condition such as a power outage or a cryocooler recondenser failure, the cooling system 14 cannot effectively re-condense the gaseous refrigerant into liquid refrigerant, and the equilibrium is lost. In this situation, the heat load of magnet 12 vaporizes the liquid refrigerant into gaseous refrigerant, and pressure within the cooling system begins to rise. The cooling system 14 contains a sufficient amount of liquid refrigerant to last a required ride-through time to allow restoration of the cooling system 14 from the failure condition. The ride-through time allows the cooling system 14 to continue to cool the magnet 12 using the liquid refrigerant remaining in the system until the supply of liquid refrigerant becomes exhausted. The ride-through time may allow, for example, the liquid refrigerant to continue to cool the magnet 12 from a half day to a full day.

During the ride-through time, the gaseous refrigerant is not re-condensed into liquid refrigerant, and the refrigerant 16 stays at its saturation line where gas and liquid coexist. A pressure build-up in the system caused by the failure of the cryocooler recondenser to re-condense the gaseous refrigerant causes the temperature of the refrigerant 16 to increase. To extend the time of the superconducting operation of the cooling system 14 during the failure condition, the pressure within the cooling system 14 is kept low.

Still referring to FIG. 1, a refrigerant reclamation circuit 30 is attached to the cooling system 14 to allow the gaseous refrigerant within the cooling system 14 to be released thereinto during the failure condition or other operational condition when it is desired to reclaim the refrigerant. A gas tank 32 is fluidly connected to the cooling system 14 and stores gaseous refrigerant flowing thereinto. A gas connection line 34 is fluidly connected to the gas tank 32 at a first end 36 and is fluidly connected to an arcuate loop 38, e.g., U-shaped, at a second end 40. Insulation 42 is attached to the gas tank 32 and to the gas connection line 34. In this manner, the gaseous refrigerant boiled-off from the cooling system 14 is kept cold, and an overall pressure rise is slowed. Gas tank 32 is sufficiently sized and reinforced to contain the gaseous refrigerant at ambient or room temperature and pressure. However, a safety relief valve 44 may be attached to gas tank 32 to allow the pressure in the gas tank 32 to vent gaseous refrigerant to the outside air if the pressure within the gas tank 32 rises above a desired level, for example, 30 bars. Relief valve 44 or an additional fill valve 46 (shown in phantom) may be used to fill the closed-loop magnet cooling system 10 with refrigerant. The closed-loop magnet cooling system 10 may be filled with gaseous refrigerant following construction or repair of the closed-loop magnet cooling system 10 or in the event of a pressure release through safety relief valve 44.

The arcuate loop 38 is fluidly connected to a top portion 48 of the liquefaction cup 24 such that gaseous refrigerant is communicated between the arcuate loop 38 and the liquefaction cup 24. The arcuate loop 38 reduces natural convection between the cooling system 14 and the gas tank 32 during normal operating conditions. During the failure condition, however, a rise in pressure in the cooling system 14 causes gaseous refrigerant to pass from the liquefaction cup 24 and into the gas tank 32 through the arcuate loop 38 and gas connection line 34. An extended failure condition period will cause all the liquid refrigerant to convert to its gaseous state.

In an alternative embodiment, a flow valve assembly may be used to reduce natural convection between the cooling system 14 and the gas tank 32. For example, a pair of anti-parallel valves may be used to control convection and flow between the cooling system 14 and the gas tank 32.

Upon restoration and initialization of the cooling system 14 to operating conditions, the cryocooler recondenser 26 begins to condense the gaseous refrigerant existing in the cooling system 14. As the gaseous refrigerant condenses to liquid refrigerant, the temperature and pressure within cooling system 14 begin to fall. As the pressure within the liquefaction cup 24 falls, a higher pressure in the reclamation circuit 30 causes the gaseous refrigerant stored therein to flow from the gas tank 32 to the liquefaction cup 24 through the arcuate loop 38 and gas connection line 34. The gaseous refrigerant stored in the gas tank 32 continues to flow into the liquefaction cup 24 until a pressure equilibrium is established between the cooling system 14 and the reclamation circuit 30. Thereafter, the cooling system 14 functions to maintain an equilibrium of the refrigerant 16 within the cooling system 14 as described above.

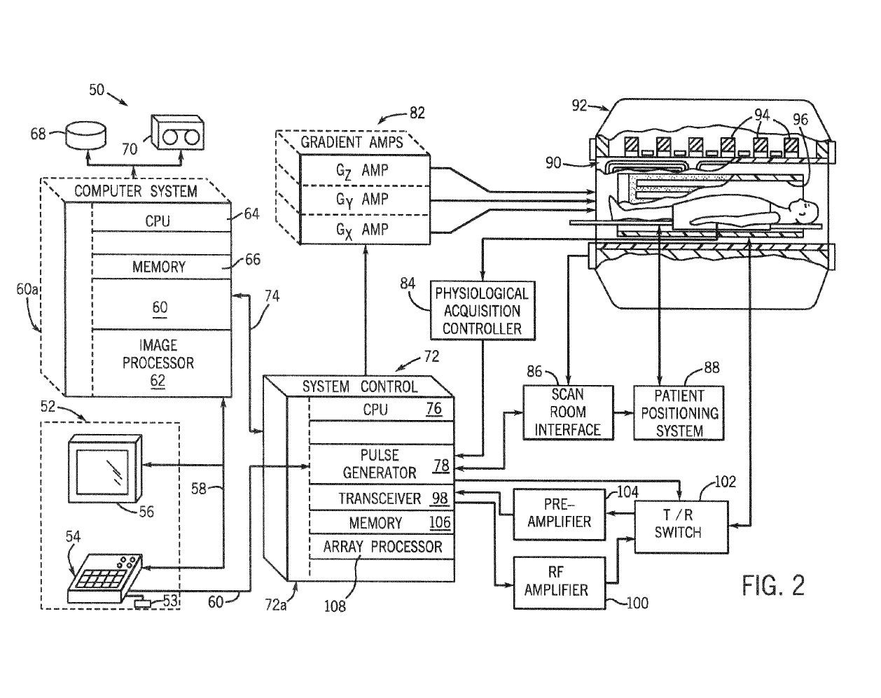

Referring now to FIG. 2, it is contemplated that the closed-loop magnet cooling system 10 may be particularly applicable, but not limited to actively cooling superconducting coils of an MR imaging system 50. As is well known, operation of the MR imaging system 50 is controlled from an operator console 52 which includes a keyboard or other input device 53, a control panel 54, and a display 56 or screen. The console 52 communicates through a link 58 with a separate computer system 60 that enables an operator to control the production and display of images on the screen 56. The computer system 60 includes a number of modules which communicate with each other through a backplane 60a. These include an image processor module 62, a CPU module 64 and a memory module 66, known in the art as a frame buffer for storing image data arrays. The computer system 60 is linked to disk storage 68 and tape drive 70 for storage of image data and programs, and communicates with a separate system control 72 through a high speed serial link 74. The input device 53 can include a mouse, joystick, keyboard, track ball, touch activated screen, light wand, voice control, or any similar or equivalent input device, and may be used for interactive geometry prescription.

The system control 72 includes a set of modules connected together by a backplane 72a. These include a CPU module 76 and a pulse generator module 78 which connects to the operator console 52 through a serial link 80. It is through link 80 that the system control 72 receives commands from the operator to indicate the scan sequence that is to be performed. The pulse generator module 78 operates the system components to carry out the desired scan sequence and produces data which indicates the timing, strength and shape of the RF pulses produced, and the timing and length of the data acquisition window. The pulse generator module 78 connects to a set of gradient amplifiers 82, to indicate the timing and shape of the gradient pulses that are produced during the scan. The pulse generator module 78 can also receive subject data from a physiological acquisition controller 84 that receives signals from a number of different sensors connected to the subject, such as ECG signals from electrodes attached to the subject. And finally, the pulse generator module 78 connects to a scan room interface circuit 86 which receives signals from various sensors associated with the condition of the subject and the magnet system. It is also through the scan room interface circuit 86 that a subject positioning system 88 receives commands to move the subject to the desired position for the scan.

The gradient waveforms produced by the pulse generator module 78 are applied to the gradient amplifier system 82 having Gx, Gy, and Gz amplifiers. Each gradient amplifier excites a corresponding physical gradient coil in a gradient coil assembly generally designated 90 to produce the magnetic field gradients used for spatially encoding acquired signals. The gradient coil assembly 90 forms part of a magnet assembly 92 which includes a polarizing magnet 94 and a whole-body RF coil 96. A transceiver module 98 in the system control 72 produces pulses which are amplified by an RF amplifier 100 and coupled to the RF coil 96 by a transmit/receive switch 102. The resulting signals emitted by the excited nuclei in the subject may be sensed by the same RF coil 96 and coupled through the transmit/receive switch 102 to a preamplifier 104. The amplified MR signals are demodulated, filtered, and digitized in the receiver section of the transceiver 98. The transmit/receive switch 102 is controlled by a signal from the pulse generator module 78 to electrically connect the RF amplifier 100 to the coil 96 during the transmit mode and to connect the preamplifier 104 to the coil 96 during the receive mode. The transmit/receive switch 102 can also enable a separate RF coil (for example, a surface coil) to be used in either the transmit or receive mode.

The MR signals picked up by the RF coil 96 are digitized by the transceiver module 98 and transferred to a memory module 106 in the system control 72. A scan is complete when an array of raw k-space data has been acquired in the memory module 106. This raw k-space data is rearranged into separate k-space data arrays for each image to be reconstructed, and each of these is input to an array processor 108 which operates to Fourier transform the data into an array of image data. This image data is conveyed through the serial link 74 to the computer system 60 where it is stored in memory, such as disk storage 68. In response to commands received from the operator console 52, this image data may be archived in long term storage, such as on the tape drive 70, or it may be further processed by the image processor 62 and conveyed to the operator console 52 and presented on the display 56.

Not only may the closed-loop magnet cooling system of the present invention be used in the MR imaging system as described above, it may be used to cool other coils of the MR imaging system for which active cooling is used. Further, the present invention is not limited to actively cooling superconducting magnetic coils used in an MR imaging system. It is contemplated that the closed-loop magnet cooling system 10 may be used in any actively cooled superconducting magnetic coil system. Additionally, the invention may be embodied in any coil cooling system where it is desirable to reclaim boiled off refrigerant as opposed to releasing such refrigerant to atmosphere.

A closed-loop magnet cooling system according to the present invention includes the advantage of reducing service costs associated with cryogen refilling services when a failure condition appears. Instead of releasing gaseous refrigerant outside the system, the present invention includes storing the released gaseous refrigerant. In this manner, the stored refrigerant is used when the system becomes operable. As such, cryogen refilling service calls are reduced. Furthermore, where a cryogen refilling service network is not established, as in a developing country, for example, the closed-loop magnet cooling system according to the present invention allows a much sooner system restart.

Therefore, in accordance with one embodiment of the invention, a magnet assembly includes a magnet and a cooling system in thermal contact with the magnet. A tank is fluidly connected to the cooling system and configured to receive and store boil-off fluid emitted from the cooling system.

In accordance with another embodiment of the invention, a superconductor system includes a superconducting magnet and a refrigerant in thermal contact with the superconducting magnet and configured to cool the superconducting magnet. A cooling system is included that is configured to condense the refrigerant from a gaseous state to a liquid state. A storage tank is fluidly connected to the cooling system and configured to store discharged refrigerant released from the cooling system.

In accordance with a further embodiment of the invention, an MRI apparatus includes a magnetic resonance imaging (MRI) system having a plurality of gradient coils positioned about a bore of a magnet to impress a polarizing magnetic field and an RF transceiver system and an RF switch controlled by a pulse module to transmit RF signals to an RF coil assembly to acquire MR images. A cryogenic cooling system is included and is in thermal contact with the magnet. A cryogen reclamation circuit is included and is fluidly connected to the cryogenic cooling system and configured to store boiled-off cryogen released by the cryogenic cooling system.

The present invention has been described in terms of the preferred embodiment, and it is recognized that equivalents, alternatives, and modifications, aside from those expressly stated, are possible and within the scope of the appending claims.

What is claimed is:

1. A magnet assembly comprising:
a magnet;
a cooling system in thermal contact with the magnet; and
a tank fluidly connected to the cooling system and configured to receive and store boil-off fluid emitted from the cooling system.

2. The assembly of claim 1 further comprising an arcuate loop fluidly connecting the cooling system to the tank and configured to reduce a natural convection between the cooling system and the tank during normal operating conditions.

3. The assembly of claim 2 wherein the cooling system further comprises:
a cryogen;
a liquid collector container configured to hold liquid cryogen;
a gas collector container configured to hold gaseous cryogen;
a liquefaction container fluidly connected to the liquid collector container and the gas collector container; and
a cryocooler recondensing unit connected to the liquefaction container and configured to condense gaseous cryogen into liquid cryogen.

4. The assembly of claim 3 wherein the arcuate loop is configured to allow gaseous cryogen to flow from the tank to the liquefaction container during a cooling system initialization.

5. The assembly of claim 3 wherein the cryogen comprises one of helium, hydrogen, neon, and nitrogen.

6. The assembly of claim 1 further comprising a heater configured to add heat to the cooling system.

7. The assembly of claim 6 wherein the heater is a pressure sensor controlled heater.

8. The assembly of claim 1 wherein the tank is thermally insulated.

9. The assembly of claim 1 wherein the tank is configured to store the boil-off gas at room temperature.

10. The assembly of claim 1 further comprising a relieve valve connected to the tank and configured to emit stored boil-off gas to the atmosphere if pressure within the tank exceeds a predetermined value.

11. The assembly of claim 1 wherein the magnet is positioned in a magnetic resonance imaging system.

12. A superconductor system comprising:
a superconducting magnet;
a refrigerant in thermal contact with the superconducting magnet and configured to cool the superconducting magnet;
a cooling system configured to condense the refrigerant from a gaseous state to a liquid state;
a storage tank fluidly connected to the cooling system and configured to store discharged refrigerant released from the cooling system.

13. The system of claim 12 further comprising a connection line fluidly connecting the cooling system to the storage tank, the connection line having a loop formed therein configured to reduce a convection between the cooling system and the storage tank when the refrigerant is not discharged from the cooling system.

14. The system of claim 13 wherein the loop is configured to allow discharged refrigerant to flow from the storage tank to the cooling system during a cooling system initialization.

15. The system of claim 12 wherein the storage tank is thermally insulated and configured to store the refrigerant in the gaseous state at a temperature substantially equal to an ambient temperature.

16. The system of claim 12 wherein the superconducting magnet is a magnetic resonance superconducting magnet.

17. An MRI apparatus comprising:
a magnetic resonance imaging (MRI) system having a plurality of gradient coils positioned about a bore of a magnet to impress a polarizing magnetic field and an RF transceiver system and an RF switch controlled by a pulse module to transmit RF signals to an RF coil assembly to acquire MR images;
a cryogenic cooling system in thermal contact with the magnet; and
a cryogen reclamation circuit fluidly connected to the cryogenic cooling system and configured to store boiled-off cryogen released by the cryogenic cooling system.

18. The apparatus of claim 17 further comprising:
an overflow path connecting the cryogenic cooling system to the cryogen reclamation circuit; and
a convection barrier loop positioned in the overflow path and configured to reduce a convection between the cryogenic cooling system and the cryogen reclamation circuit when the cryogenic cooling system is operating.

19. The apparatus of claim 17 further comprising:
a cryogen;
a liquid cryogen vessel configured to contain liquid cryogen;
a gaseous cryogen vessel configured to contain gaseous cryogen;
a liquefaction cup in fluid communication with the liquid cryogen vessel and the gaseous cryogen vessel; and
a cryogen recondenser connected to the liquefaction cup and configured to condense gaseous cryogen into liquid cryogen.

20. The apparatus of claim 17 wherein the cryogen reclamation circuit further comprises a thermally insulated cryogen reclamation configured to store gaseous cryogen at ambient temperature.
